(19) United States
(12) Patent Application Publication
(10) Pub. No.: US 2013/0123399 A1
(43) Pub. Date: May 16, 2013

(54) PVB FILM COMPRISING PHENOLIC ANTIOXIDANTS HAVING THE PARTIAL STRUCTURE 3-T-BUTYL-4-HYDROXY-5-METHYLPHENYL PROPRIONATE

(71) Applicant: Uwe Keller, Bonn (DE)

(72) Inventor: Uwe Keller, Bonn (DE)

(73) Assignee: KURARAY EUROPE GMBH, Hattersheim (DE)

(21) Appl. No.: 13/697,071

(22) PCT Filed: May 6, 2011
(86) PCT No.: PCT/EP2011/057329

§ 371 Date: Jan. 29, 2013

(30) Foreign Application Priority Data
May 11, 2010 (DE) 10 2010 028 855.1

(51) Int. Cl. C08L 31/02; C08K 5/1575; C08K 5/12

(52) U.S. Cl. CPC C08L 31/02; C08K 5/12; C08K 5/1575
USPC 524/108; 524/291

(57) ABSTRACT

The invention relates to thermoplastic mixtures or to films produced therefrom, containing at least one polyvinyl acetal and at least one plasticiser, characterised by the addition of 0.001 to 1% by weight of at least one compound according to formula 1, where R=a hydrocarbon radical of a polyfunctional alcohol, oligoglycols comprising 1 to 10 glycol units or a hydrocarbon radical comprising 1 to 20 carbon atoms, and X=1, 2, 3 or 4 as a stabiliser.

### TECHNICAL FIELD

The invention relates to mixtures of plasticiser-containing polyvinyl acetals or to films extruded therefrom, having low natural colour and high photothermal stability by use of particularly suitable phenolic antioxidants.

### PRIOR ART

Similarly to many other thermoplastics, polyvinyl butyral is often provided with phenolic antioxidants (phenolic AOs), of which the purpose is to inhibit radical cleavage reactions, for example triggered by high processing temperatures during film extrusion. The length of the polymer chains is thus kept substantially constant, so that the mechanical properties of the extruded material are not impaired as a result of the extrusion process.

However, many phenolic antioxidants are associated with the disadvantage of causing yellowing, depending on the extrusion conditions, which can be attributed to reaction products of the antioxidants. Even in a finished PVB film already glued between two glass panes, phenolic antioxidants can cause subsequent yellowing under UV irradiation, in particular at increased temperature, which is not only undesirable for aesthetic reasons, but also reduces the light transmission of the glass laminate over time.

For example, the dinuclear phenolic antioxidants, such as Lowinox 44B25 and 22M46, preferred in WO 03/078160 A1 (DuPont) for PVB films comprising the plasticiser 3G8, have been found to demonstrate particularly yellowing behaviour under UV irradiation.

Some antioxidants, such as BHT (CAS reg. no.: 128-37-0), are indeed UV-stable, but are relatively volatile due to their low molecular weight, and therefore the antioxidant may become depleted prematurely along the edge of the laminate in the film substance not covered by the glass, and the polymer chains at these points of the film may no longer be protected against chain degradation. In addition, BHT has the disadvantage that intensively yellow-coloured reaction products may be produced at increased temperature and with an influx of atmospheric oxygen. With application as a laminated safety glass or photovoltaic module, these reaction products may manifest themselves as a defect in the form of yellowing of the PVB film in the edge region of the laminate after the autoclave process or durability tests.

### PROBLEM

The problem addressed by the present invention was to identify a phenolic antioxidant which is suitable specifically for the high demands encountered with production of films from plasticiser-containing polyvinyl acetals by extrusion and which can be used for optical applications, that is to say which do not demonstrate any yellowing at the edges of the laminated film, do not increase the yellowness index unacceptably during extrusion, and demonstrate particularly good photothermal stability.

### SOLUTION TO THE PROBLEM

It has surprisingly been found that films made of plasticiser-containing polyvinyl acetal having low natural colour and particularly high photothermal stability can be obtained by using phenolic antioxidants comprising units of 3-t-butyl-4-hydroxy-5-methylphenyl proprionates as a partial structure.

The present invention therefore relates to thermoplastic mixtures containing at least one polyvinyl acetal and at least one plasticiser or to a film produced therefrom, characterised by the addition of 0.001 to 1% by weight of at least one compound of formula 1

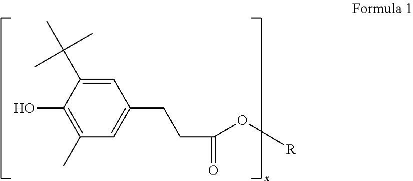

where R=a hydrocarbon radical of a polyfunctional alcohol, oligoglycols comprising 1 to 10 glycol units or a hydrocarbon radical comprising 1 to 20 carbon atoms, and X=1, 2, 3 or 4 as a stabiliser.

Suitable stabilisers of formula 1 include those of formula la for example

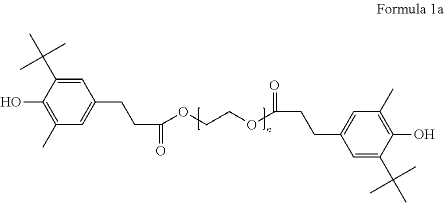

where n=1 to 10, or those of formula 1b

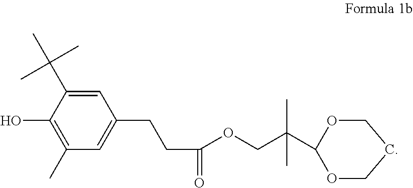

The present invention further relates to the use of compounds according to formula 1, 1a or 1b as a stabiliser for thermoplastic mixtures formed of at least one plasticiser and at least one polyvinyl acetal.

Suitable stabilisers according to formula 1, 1a or 1b are those having CAS reg. no. 36443-68-2, which are obtainable for example from CIBA in the form of IRGANOX 245, from CHEMITURA in the form of Lowinox GP45 or from SONGWON in the form of Songnox 2450, as well as those having CAS reg. no. 90498-90-1, which are obtainable from Sumimoto under the name SUMILIZER GA 80.

Mixtures or films according to the invention preferably contain 0.005 to 0.5% by weight, more preferably 0.01 to 0.25% by weight, in particular 0.02 to 0.1% by weight, and most preferably 0.03 to 0.08% by weight, of phenolic antioxidants having the partial structure 3-t-butyl-4-hydroxy-5-methylphenyl proprionate according to formula 1.

In addition to the use of the stabilisers according to formula 1, 1a or 1b, the setting of a low alkali titre of the mixture according to the invention, for example with neutralisation of the polyvinyl acetal, may result in improved natural colour and photothermal stability of the mixture or film according to the invention.

As disclosed in the examples, the alkali titre is determined by neutralisation of the mixture or film according to the invention with hydrochloric acid and preferably lies between 2 and 70, in particular between 3 and 50, and most preferably between 5 and 30.

The alkali titre can be set by corresponding neutralisation of the polyvinyl acetal, either during or after production thereof as a result of acetalisation of polyvinyl alcohol, or by addition of metal salts to the mixture according to the invention. The metal salts generally also act as anti-stick agents with use of the films according to the invention for laminated safety glass laminates.

Polyvinyl acetals obtainable as acetalisation products of polyvinyl alcohol PVA with butyraldehyde, that is to say polyvinyl butyral (PVB), are particularly suitable for the mixture according to the invention. Mixtures according to the invention may contain one or more polyvinyl acetals, which may differ in terms of molecular weight, degree of acetalisation, residual alcohol content or nature of the acetal group.

Mixtures or films according to the invention may contain alkaline earth metal ions, zinc ions, aluminium ions or alkali metal ions as anti-stick agents. These are generally present in the mixture/film in the form of salts of monovalent or polyvalent inorganic or monovalent or polyvalent organic acids. Examples of counterions include, for example, salts of organic carboxylic acids, such as formates, acetates, trifluoroacetates, proprionates, butyrates, benzoates, 2-ethylhexanoates, etc., wherein carboxylic acids comprising fewer than 10 C atoms, preferably fewer than 8 C atoms, preferably fewer than 6 C atoms, preferably fewer than 4 C atoms, and more preferably comprising fewer than 3 C atoms are preferably used. Examples of inorganic counterions include chlorides, nitrates, sulfates and phosphates. Further counterions may be anions to be assigned to the surfactants, such as sulfonates or phosphate surfactants.

The aforementioned favourable optical properties of the mixture according to the invention can also be improved by selection of the polyvinyl alcohol (PVA) used to produce the polyvinyl acetal. If, at the stage of the PVA, unsaturated units are present in the polymer chain as flaws, these will necessarily also be found again in the polyvinyl acetal produced therefrom, whereby the absorption of UV radiation of said polyvinyl acetal is increased and the light stability thereof is impaired. The unsaturated units may be present in the form of isolated double bonds or double bonds provided in conjugation with one another or in conjugation with carbonyl bonds. These unsaturated units can be detected in the PVA by UV spectroscopy.

Very high proportions of flaws lead to extinctions at 280 nm of close to 1 when measuring the used PVA in 4% by weight solution in H₂O. Polyvinyl alcohols having extinction values in a 4% by weight aqueous solution at 280 nm of less than 0.5, of less than 0.3, in particular 0.2, and preferably 0.1, are therefore preferably used for the production of polyvinyl acetal used in accordance with the invention.

Due to their good natural photothermal stability, compounds of the benzotriazole type, in particular of the Tinuvin 328, 327 and 326 type, are additionally suitable as UV absorbers. The present invention expressly includes the use of benzotriazoles. Films produced therewith do have a relatively high natural colour, but also have particularly low delta b* values in accordance with irradiation testing.

In addition to the use of phenolic antioxidants having the partial structure 3-t-butyl-4-hydroxy-5-methylphenyl proprionate according to formula 1, and instead of, or in addition to, the above-mentioned volatile antioxidants, the mixtures or films according to the invention may also be provided with one or more non-aromatic light stabilisers, in particular with 0.001 to 1% by weight (based on the film mixture) of sterically hindered amines of the HAS/HALS/NOR-HALS type (sterically hindered amino ethers), whereby a further improvement to photothermal stability can be achieved.

Particularly suitable non-aromatic light stabilisers are sterically hindered amines of general formulas II, III and/or IV

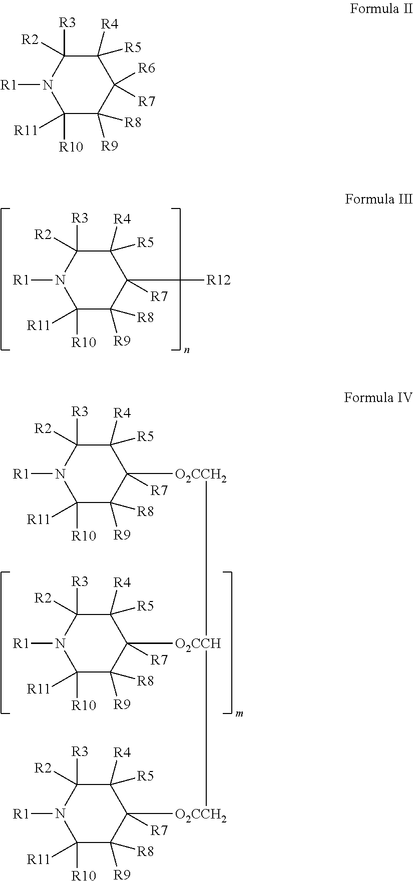

where R1, R2, R3, R4, R5, R6, R7, R8, R9, R10, R11=non-aromatic substituents, such as H, C1-C20 alkyl, hydroxyalkyl, alkoxyalkyl, acyloxyalkyl, in each case unsubstituted or substituted by aldehyde, keto or epoxy groups.
R12=smooth compound, C1-C20 alkyl, hydroxyalkyl, alkoxyalkyl, acyloxyalkyl, in each case unsubstituted or substituted by aldehyde, keto or epoxy groups
n=2-4
m=1-10.

Compounds of this type are commercially available; for example Tinuvin 123 (NOR-HALS), Tinuvin 144, Tinuvin 622, Tinuvin 770 and the Di-N-methylated derivative thereof are suitable and are obtainable from Ciba Specialities. ADK Stab LA-57, LA-52 or LA-62 by Asahi Denka Co. or UVINUL 4050 H by BASF AG are particularly well suited.

In addition to use of phenolic antioxidants having the partial structure 3-t-butyl-4-hydroxy-5-methylphenyl proprionate according to formula 1, the thermoplastic mixtures/films may contain basic stabilisation by means of a further phenolic antioxidant that is photostable due to other properties, such as high volatility for example, and that is less suitable when considered in isolation. Within the scope of the present invention, this therefore means antioxidants having increased volatility under the extrusion and processing conditions of PVB film, which generally concerns phenolic antioxidants having a molecular weight of less than 300 g/mol. These additional phenolic antioxidants can be used instead of, or in combination with, the aforementioned sterically hindered amines of the HAS/HALS/NOR-HALS type. The thermoplastic mixture or films according to the invention preferably contain phenolic antioxidants having a molecular weight of less than 300 g/mol in an amount of 0.001-0.25% by weight (based on the film mixture). Particularly suitable phenolic antioxidants include BHT (CAS reg. no.: 128-37-0) or 4-tert-octylphenol (CAS reg. no.: 140-66-9).

The sterically hindered phenolic antioxidants having the partial structure 3-t-butyl-4-hydroxy-5-methylphenyl proprionate of formula 1 and, where applicable, the further antioxidants can be introduced into the mixture or film produced therewith according to the invention in various ways. They may already be contained in the polymer before extrusion or may be added dissolved or suspended in the plasticiser during the extrusion process or at the stage of blend production. The phenolic antioxidants are preferably already introduced at the stage of PVB synthesis, for example by being sprayed onto the finished polymer particles or during precipitation of the PVB polymer from the reaction solution. The same applies to the addition of the sterically hindered amine light stabilisers, wherein these are preferably added dissolved in the plasticiser.

The films preferably have a total plasticiser content, that is to say the proportion of all plasticisers in the film, in the range of 5 to 45% by weight, 12 to 36% by weight, 14 to 32% by weight, 16 to 30% by weight, and in particular 20 to 28% by weight. Films or laminates glued therewith according to the invention may contain one or more plasticisers.

Plasticisers that are suitable in principle for the mixtures or films according to the invention are one or more compounds selected from the following groups:

Esters of polyvalent aliphatic or aromatic acids, for example dialkyl adipates such as dihexyl adipate, dioctyl adipate, hexylcyclohexyl adipate, mixtures of heptyl adipates and nonyl adipates, diisononyl adipate, heptylnonyl adipate and adipic acid esters with ester alcohols containing cycloaliphatic or ether bonds, dialkyl sebacates such as dibutyl sebacate, and sebacic acid esters with ester alcohols containing cycloaliphatic or ether bonds, phthalic acid esters such as butyl benzyl phthalate or bis-2-butoxyethyl phthalate

esters or ethers of polyvalent aliphatic or aromatic alcohols or oligoetherglycols with one or more unbranched or branched aliphatic or aromatic substituents, such as diglycol, triglycol or tetraglycol esters with linear or branched aliphatic or cycloaliphatic carboxylic acids;

examples of the latter group include diethylene glycol-bis-(2-ethylhexanoate), triethylene glycol-bis-(2-ethylhexanoate), triethylene glycol-bis-(ethylbutanoate), tetraethylene glycol-bis-n-heptanoate, triethylene glycol-bis-n-heptanoate, triethylene glycol-bis-n-hexanoate, tetraethylene glycol dimethyl ether and/or dipropylene glycol benzoate

phosphates with aliphatic or aromatic ester alcohols, such as tris(2-ethylhexyl)phosphate (TOF), triethyl phosphate, diphenyl-2-ethylhexyl phosphate, and/or tricresyl phosphate

citric acid esters, succinic acid and/or fumaric acid.

Well-suited plasticisers for the mixtures or films according to the invention include one or more compounds selected from the following group: di-2-ethylhexyl sebacate (DOS), di-2-ethylhexyl adipate (DOA), dihexyl adipate (DHA), dibutyl sebacate (DBS), diisononyl adipate (DINA), triethylene glycol-bis-n-heptanoate (3G7), tetraethylene glycol-bis-n-heptanoate (4G7), triethylene glycol-bis-2-ethylhexanoate (3GO or 3G8), tetraethylene glycol-bis-n-2-ethylhexanoate (4GO or 4G8), di-2-butoxyethyl adipate (DBEA), di-2-butoxyethoxyethyl adipate (DBEEA), di-2-butoxyethyl sebacate (DBES), di-2-ethylhexyl phthalate (DOP), di-isononyl phthalate (DINP) triethylene glycol-bis-isononanoate, triethylene glycol-bis-2-propyl hexanoate, tris(2-ethylhexyl)phosphate (TOF), 1,2-cyclohexane dicarboxylic acid diisononyl ester (DINCH) and dipropylene glycol benzoate.

Plasticisers of which the polarity, expressed by the formula 100×O/(C+H), is less than/equal to 9.4 are most suited, wherein O, C and H stand for the number of oxygen, carbon and hydrogen atoms in the respective molecule. The following table shows plasticisers than can be used in accordance with the invention and the polarity values thereof according to the formula 100×O(C+H).

TABLE 1

| | | 100 × O/ |
|---|---|---|
| Name | Abbreviation | (C + H) |
| di-2-ethylhexyl sebacate | (DOS) | 5.3 |
| diisononyl adipate | (DINA) | 5.3 |
| 1,2-cyclohexane | (DINCH) | 5.4 |
| dicarboxylic acid | | |
| diisononyl ester | | |
| di-2-ethylhexyl adipate | (DOA) | 6.3 |
| dihexyl adipate | (DHA) | 707 |
| dibutyl sebacate | (DBS) | 7.7 |
| triethylene glycol-bis-2- | | 8.6 |
| propyl hexanoate | | |
| triethylene glycol-bis-i- | | 8.6 |
| nonanoate | | |
| di-2-butoxyethyl sebacate | (DBES) | 9.4 |
| triethylene glycol-bis-2- | (3G8) | 9.4 |
| ethylhexanoate | | |

Furthermore, the mixtures or films according to the invention may additionally contain further additives, such as antistatic agents, fillers, IR-absorbing nanoparticles or chromophores, dyes, surface-active substances, chelating agents, compounds containing epoxy groups, pigments and adhesion regulators.

The basic production and composition of films based on polyvinyl acetals is described in EP 185 863 B1, EP 1 118 258 B1, WO 02/102591 A1, EP 1 118 258 B1 or EP 387 148 B1.

Thermoplastic mixtures according to the invention can be extruded in the normal manner at approximately 160 to 230° C. to form a film. Such films preferably have a DYI of less than 5, more preferably less than 4, and in particular less than 3, and a delta b* value of less than 3, preferably less than 2.5, more preferably less than 2, and in particular less than 1.5.

The films according to the invention can be used to produce laminated safety glass laminates, windscreens or photovoltaic modules.

### Test and Measurement Methods

The irradiation resistance of the films was tested in laminated safety glass between two panes of glass 2 mm thick of the Optiwhite® type (low-iron glass by Pilkington with increased permeability to UV-A radiation compared to typical clear glass). Laminates measuring 15×15 cm were placed in the irradiation chamber in accordance with EN 12543 for a period of 20 weeks. By contrast to the conditions of EN 12543, a higher sample temperature of 80° C. was set in a constant manner, since this corresponds more closely to a combined radiation and temperature load as actually occurs during application in adverse conditions.

By taking a comparative measurement of the b* value (CIELab) of the irradiated laminate compared to an original laminate stored in the dark, the relative increase in the b* value can easily be established as a measure for the radiation resistance of the PVB film with the respective stabiliser type or the respective stabiliser combination. The b* value is measured using a “ColorQuest XE” colour measurement spectrophotometer by Hunterlab in the CIELAb system in transmission (10°/D65). The delta b* value is given as the difference between the b* value of the irradiated sample and the b* value of the original sample.

For the purpose of improved differentiation of the natural colour of the extruded film (without additional load by irradiation), a laminated safety glass having 10 layers of film 0.76 mm thick (total film thickness thus 7.6 mm) with two panes of clear glass (2 mm Planilux®) is measured on the ColorQuest XE in accordance with the following method. With the method, the natural colour of the glass is established by calibrating the pane pairing of the identical glass batch as a reference sample. The yellowness index (YI [D1925]) is calculated automatically in accordance with the following conditions: Hunterlab 2°/light type C. The value DYI is the difference from YI (laminate 10×0.76)−YI (glass pair).

The thermo-oxidative stability (edge stability) is assessed on test laminates made of 2×3 mm float glass measuring 15×15 cm. After a conventional pre-laminated rolling step, the test laminates are subjected to an extended and hot autoclave process for production of the final composite, which, with a total duration of 6 h, includes a holding time of 3h at 160° C. and 12 bar. In this case, the film mass located at the edge of the test laminate is coloured to an extent ranging from “not at all” to “dark amber” as a result of the thermo-oxidative load and according to the selected stabilising variants. The former is assigned the score 0 whilst the latter is assigned the score 6, with corresponding gradations therebetween.

The polyvinyl alcohol and polyvinyl alcohol acetate content of the polyvinyl acetals was determined in accordance with ASTM D 1396-92. The metal ion content was analysed by atomic absorption spectroscopy (AAS). The water or moisture content of the films was determined using the Karl Fischer method.

To determine the UV absorption of the polyvinyl alcohol used in the acetalisation process, said polyvinyl alcohol was measured in a UV/VIS spectrometer, for example Perkin-Elmer Lambda 910, as 4% aqueous solution in a layer thickness of 1 cm at the wavelength 280 nm. In this case, the measured value is based on the dry material content of the PVA.

To determine the alkali titre, 3 to 4 gr. of the plasticiser-containing polyvinyl acetal film were dissolved in 100 ml of a mixture of ethanol/THF (80:20) in a magnetic stirrer overnight. 10 ml of a diluted hydrochloric acid (c=0.01 mol/litre) were added to this mixture, which was then titrated potentiometrically with a solution of tetrabutylammonium hydroxide (TBAH) in 2-propanol (c=0.01 mol/litre) using a titroprocessor against a blank sample. The alkali titre was calculated as follows:

Alkali titre=ml HCl per 100 gr of a sample=(consumption TBAH blank sample−TBAH sample×100 by weight of the sample in gr.)

### EXAMPLES

Mixtures given in the following tables were extruded on an extruder having a throughput of 85 kg/h and at a mass temperature of 200° C. to form films 0.76 mm thick. All figures given as % by weight are based on the film mixture, unless indicated otherwise.

The following terms are used

| | |
|---|---|
| water content | water content of the film mixture at |
| | the time of lamination |
| PVA | PVA content of the PVB in % by weight |
| | based on PVB |
| extinction | extinction of the PVA at 280 nm |
| MgAc | magnesium acetate tetrahydrate |
| Tinuvin 328 | UV absorber of the benzotriazole type |
| Tinuvin 770 | HALS, Ciba Specialities |
| Songnox 2450 | Songwon, stabiliser according to the |
| | invention |
| Sumilizer GA-80 | Sumimoto, stabiliser according to the |
| | invention |
| BHT | phenolic antioxidant with molecular |
| | weight less than 300 g/mol |
| Lowinox 44B25 | phenolic antioxidant, not according to |
| | the invention |
| Irganox 1076 | phenolic antioxidant, not according to |
| | the invention |

In addition to a stabiliser according to the invention, the compositions in Examples 2, 4 and 7 contain an antioxidant having a molecular weight of less than 300 g/mol; Example 5 also contains a HALS stabiliser.

Comparative examples 1 and 2 contain merely conventional stabilisers and no stabiliser according to the invention having the partial structure of formula 1, 1a or 1b. In addition to a much worsened thermo-oxidative stability (CE1), the films demonstrate unacceptable colouring, expressed by the delta b* and DYI values.

TABLE 2

| Composition of the film | E1 | E2 | E3 |
|---|---|---|---|
| PVB | 72.5 | 72.5 | 72.5 |
| PVA | 20.1 | 20.1 | 20.1 |
| Extinction | <0.5 | <0.5 | <0.5 |
| 3G8 | 25 | 25 | 25 |
| DBEA | 2.5 | 2.5 | 2.5 |
| DINCH | — | — | — |
| DINA | — | — | — |
| MgAc | 0.0125 | 0.0125 | 0.0125 |
| Tinuvin 328 | 0.15 | 0.15 | 0.15 |
| Tinuvin 770 | — | — | — |
| Songnox 2450 | 0.12 | 0.04 | — |
| Sumilizer GA-80 | — | — | 0.12 |
| BHT | — | 0.06 | — |
| Lowinox 44B25 | — | — | — |
| Irganox 1076 | — | — | — |
| Test results on the film/in the | | | |
| laminate | | | |
| water content | 0.44 | 0.45 | 0.44 |
| alkali titre | 14 | 13 | 14 |
| DYI | 2.4 | 2.3 | 2.5 |
| delta b* | 1.1 | 1.0 | 0.7 |
| thermo-oxidative stability | 2 | 1 | 0 |

TABLE 3

| Composition of the film | E4 | E5 | E6 |
|---|---|---|---|
| PVB | 72.5 | 72.5 | 74 |
| PVA | 20.1 | 20.1 | 15.2 |
| Extinction | <0.5 | <0.5 | <0.5 |
| 3G8 | 25 | 25 | — |
| DBEA | 2.5 | 2.5 | — |
| DINCH | — | — | 13 |
| DINA | — | — | 13 |
| MgAc | 0.0125 | 0.0125 | 0.0125 |
| Tinuvin 328 | 0.15 | — | 0.15 |
| Tinuvin 770 | — | 0.075 | — |
| Songnox 2450 | — | 0.12 | 0.12 |
| Sumilizer GA-80 | 0.04 | — | |
| BHT | 0.06 | — | — |
| Lowinox 44B25 | — | — | — |
| Irganox 1076 | — | — | — |
| Test results on the film/in the | | | |
| laminate | | | |
| water content | 0.45 | 0.44 | 0.44 |
| alkali titre | 13 | 28 | 15 |
| DYI | 2.3 | 1.4 | 2.0 |
| delta b* | 0.8 | 0.5 | 0.8 |
| thermo-oxidative stability | 0 | 2 | 0 |

TABLE 4

| Composition of the film | E7 | CE1 | CE2 |
|---|---|---|---|
| PVB | 74 | 72.5 | 72.5 |
| PVA | 15.2 | 20.1 | 20.1 |
| Extinction | <0.5 | <0.5 | <0.5 |
| 3G8 | | 25 | 25 |
| DBEA | | 2.5 | 2.5 |
| DINCH | 13 | — | — |
| DINA | 13 | — | — |
| MgAc | 0.0125 | 0.0125 | 0.0125 |
| Tinuvin 328 | 0.15 | 0.15 | 0.15 |
| Tinuvin 770 | — | | — |
| Songnox 2450 | 0.04 | | — |
| Sumilizer GA-80 | — | — | — |
| BHT | 0.06 | — | — |
| Lowinox 44B25 | — | — | 0.12 |
| Irganox 1076 | — | 0.12 | — |
| Test results on the film/in the | | | |
| laminate | | | |
| water content | 0.42 | 0.45 | 0.44 |
| alkali titre | 14 | 14 | 13 |
| DYI | 1.8 | 7.8 | 3.2 |
| delta b* | 0.9 | 7.9 | 5.5 |
| thermo-oxidative stability | 1 | 6 | 0 |

1.-14. (canceled)

15. A thermoplastic mixture containing at least one polyvinyl acetal and at least one plasticiser, characterised by the addition of 0.001 to 1% by weight of at least one compound according to formula 1 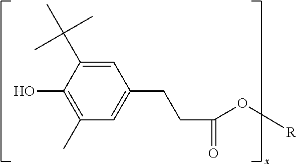
where R=a hydrocarbon radical of a polyfunctional alcohol, bifunctional cyclic ether, bifunctional cyclic diether, bifunctional dioxane derivative, oligoglycols comprising 1 to 10 glycol units or a hydrocarbon radical comprising 1 to 20 carbon atoms, and X=1, 2, 3 or 4 as a stabiliser.

16. The thermoplastic mixture according to claim 15, characterised in that stabilisers of formula 1a 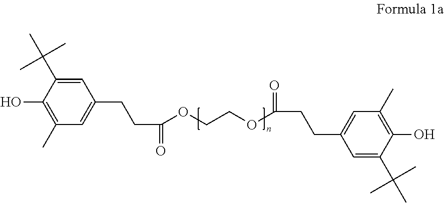
where n=1 to 10 are used as stabilisers of formula 1.

17. The thermoplastic mixture according to claim 15, characterised in that stabilisers of formula 1b 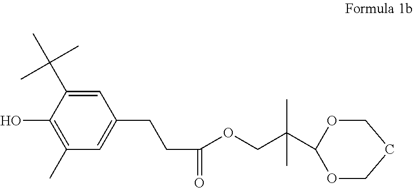 [SMILES: Cc1cc(CCC(=O)OCC(C)(C)C2OCCCO2)cc(C(C)(C)C)c1O]
are used as stabilisers of formula 1.

18. The thermoplastic mixture according to claim 15, characterised in that stabilisers having CAS reg. no. 36443-68-2 or CAS reg. no. 90498-90-1 are used as stabilisers of formula 1.

19. The thermoplastic mixture according to claim 15, characterised in that the mixture has an alkali titre of 2 to 70.

20. The thermoplastic mixture according to claim 15, characterised in that the mixture additionally contains 0.001 to 1% by weight of non-aromatic light stabilisers of the HAS/HALS/NOR-HALS type.

21. The thermoplastic mixture according to claim 15, characterised in that the mixture additionally contains phenolic antioxidants having a molecular weight of less than 300 g/mol in an amount of 0.001 to 0.25% by weight.

22. A film, produced from a thermoplastic mixture according to claim 15.

23. The film according to claim 22, characterised in that the film has a delta b* value of less than 3.

24. The film according to claim 23, characterised in that the film has a natural colour DYI of less than 5.

25. A laminated safety glass laminate, windscreen or photovoltaic module containing a film according to claim 22.

26. A method of stabilizing a thermoplastic mixture containing at least one plasticizer and at least one polyvinyl acetal, comprising adding to said mixture a compound of formula 1 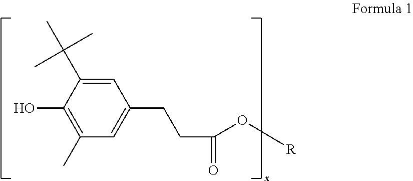
where R=a hydrocarbon radical of a polyfunctional alcohol, oligoglycols comprising 1 to 10 glycol units or a hydrocarbon radical comprising 1 to 20 carbon atoms, and X=1, 2, 3 or 4 as a stabiliser.
